(19) United States
(12) Patent Application Publication
(10) Pub. No.: US 2026/0322607 A1
(43) Pub. Date: Oct. 15, 2026

(54) AUTHENTICATION METHOD, AUTHENTICATION SYSTEM, PROVISIONING SERVER, AND PROGRAM

(71) Applicant: KAMOME Engineering, Inc., Tokyo (JP)

(72) Inventors: Kohji OSAMURA, Awara-shi (JP); Takeshi SHIOMURA, Zushi-shi (JP)

(73) Assignee: KAMOME Engineering, Inc., Tokyo (JP)

(21) Appl. No.: 19/705,876

(22) Filed: Jun. 12, 2026

Related U.S. Application Data
(63) Continuation of application No. PCT/JP2023/045103, filed on Dec. 15, 2023.

(51) Int. Cl. H04L 9/32; H04L 9/40

(52) U.S. Cl. CPC H04L 9/3213; H04L 9/3247; H04L 9/40

(57) ABSTRACT

The authentication server transmits token data to the user terminal, and transmits the authentication result of the token data transmitted from the provisioning server to the provisioning server. The provisioning server 2 includes: an issuing unit that transmits a registration code associated with the token data to the user terminal upon receipt of the token data from the user terminal; and a connecting unit that transmits the token data associated with the registration code to the authentication server upon receipt of the request for establishment of a tunnel between the processing unit and the user terminal from the user terminal and the registration code, and that establishes a tunnel between the processing unit and the user terminal upon receipt of the result of authentication from the authentication server.

### CROSS-REFERENCE TO RELATED APPLICATION(S)

This application is based upon and claims the benefit of priority from PCT Application No. PCT/JP2023/045103, filed Dec. 15, 2023; the entire contents of which are incorporated herein by reference.

### TECHNICAL FIELD

This disclosure relates to an authentication method, an authentication system, a provisioning server, and a program.

### BACKGROUND

SSH (Secure Shell) is known (see Non-Patent Literature 1). SSH is an encrypted network protocol. According to SSH, protected communication paths can be established over unprotected networks. Using the protected communication paths, a provisioning server can operate a network service securely. In this specification, a communication path protected by SSH on unprotected networks is referred to as an SSH tunnel, or a tunnel.

Furthermore, single sign-on (SSO) is known (see Non-Patent Literature 2). In SSO, a user can use resources of another independent software system after being authenticated by a single authentication process.

### CITATION LIST

### Non-Patent Literature

Non-Patent Literature 1: “Secure Shell” [online], WIKIPEDIA, [version Aug. 18, 2023], Internet <URL: https://en.wikipedia.org/wiki/Secure_Shell>

Non-Patent Literature 2: “Single sign-on” [online], WIKIPEDIA, [version Aug. 18, 2023], Internet <URL: https://en.wikipedia.org/wiki/Single_sign-on>

### SUMMARY OF THE INVENTION

### Technical Problem

However, depending on software implementing SSH, the amount of data for authentication information that can be transmitted before establishing a tunnel, such as at the time of authentication, is limited. However, in an authentication server such as single sign-on, the amount of data for user authentication tends to be large in order to ensure security.

Therefore, if the amount of data for authentication information that can be transmitted before establishing a tunnel is limited, the authentication server may not be able to authenticate a user terminal with a sufficient amount of data to ensure security. In such a situation, the tunnel cannot be established with sufficient security.

The present disclosure has been made in view of the circumstances above, and an object of the present disclosure is to provide a technology that can establish a tunnel with sufficient security even when the amount of data for authentication information that can be transmitted is limited.

### Solution to Problem

An authentication method according to an aspect of the present disclosure includes, i an authentication system that includes a user terminal, a provisioning server for providing an application, and an authentication server for authenticating a use of the provisioning server by the user terminal: the user terminal transmits the token data to the provisioning server, the provisioning server transmits a registration code associated with the token data to the user terminal upon receipt of the token data from the user terminal, the user terminal transmits the registration code as authentication information to the provisioning server by SSH to request establishment of a tunnel between a processing unit of an application provided by the provisioning server and the user terminal, the provisioning server receives the registration code from the user terminal and identifies the token data associated with the received registration code, the provisioning server transmits the identified token data to the authentication server, the authentication server transmits an authentication result of the token data transmitted from the provisioning server to the provisioning server, the provisioning server establishes the tunnel between the processing unit and the user terminal upon receipt of the authentication result indicating successful authentication from the authentication server, and wherein the size of the token data exceeds the size of data of authentication information that can be transmitted by SSH, and the size of the registration code is within the size of data of the authentication information that can be transmitted by SSH.

An authentication system includes: a user terminal; a provisioning server for providing an application; and an authentication server for authenticating a use of the provisioning server by the user terminal, in which the authentication server transmits token data for authenticating the user terminal to the user terminal; and transmits an authentication result of the token data transmitted from the provisioning server to the provisioning server,
the user terminal transmits the token data to the provisioning server and receives a registration code from the provisioning server; and transmits the registration code as authentication information to the provisioning server by SSH to request establishment of a tunnel between a processing unit of the application provided by the provisioning server and the user terminal, the provisioning server comprises a processing unit, including one or more processors, configured to provide an application, an issuing unit, including one or more processors, configured to transmit a registration code associated with the token data to the user terminal upon receipt of the token data from the user terminal, and a connecting unit, including one or more processors, configured to transmit the token data associated with the registration code to the authentication server upon receipt of a request for establishing a tunnel between the processing unit and the user terminal from the user terminal, and the registration code; and establish a tunnel between the processing unit and the user terminal upon receipt of a result indicating successful authentication from the authentication server, and wherein the size of the token data exceeds the size of data of authentication information that can be transmitted by SSH, and the size of the registration code is within the size of data of the authentication information that can be transmitted by SSH.

The provisioning server according to an aspect of the present disclosure includes a processing unit, including one or more processors, configured to provide an application, an issuing unit, including one or more processors, configured to, upon receipt of token data from a user terminal, transmit a registration code associated with the token data to the user terminal, the token data used for authenticating the user terminal, a connecting unit, including one or more processors, configured to transmit the token data associated with the registration code to the authentication server upon receipt of a request for establishing a tunnel between the processing unit and the user terminal and the registration code as authentication information by SSH from the user terminal; and establish the tunnel between the processing unit and the user terminal upon receipt of a result indicating successful authentication from the authentication server, and wherein the size of the token data exceeds the size of data of authentication information that can be transmitted by the SSH, and the size of the registration code is within the size of data of the authentication information that can be transmitted by the SSH.

An aspect of the present disclosure is a non-transitory tangible medium storing a program, where executing of the program causes one or more processors to perform operations of the provisioning server.

### Advantageous Effects of Invention

According to the present disclosure, it is possible to provide a technology capable of establishing a tunnel with sufficient security even when the amount of data of authentication information that can be transmitted is limited.

### BRIEF DESCRIPTION OF DRAWINGS

FIG. 1 is a diagram for explaining a system configuration of an authentication system according to the present disclosure, and functional blocks of a provisioning server.

FIG. 2 is a diagram for explaining an example of a data configuration of associating data.

FIG. 3 is a sequence diagram for explaining processing in an authentication system. (Part 1)

FIG. 4 is a sequence diagram for explaining processing in an authentication system. (Part 2)

FIG. 5 is a diagram for explaining a hardware configuration of a computer used for a provisioning server.

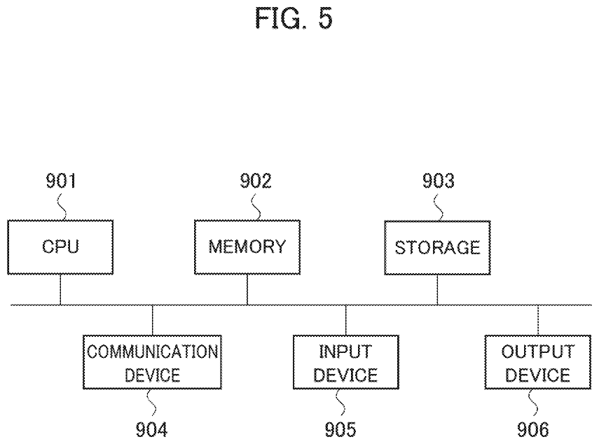

### DESCRIPTION OF EMBODIMENTS

An embodiment of the present disclosure will be described below with reference to the drawings. In the description of the drawings, the same parts are denoted by the same reference numerals, and the description thereof will be omitted.

### Authentication System

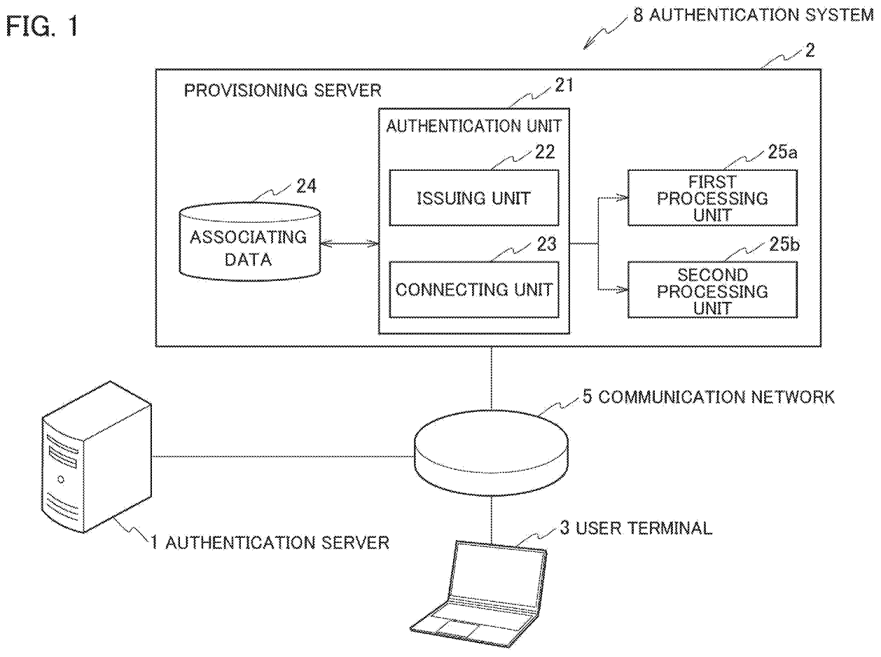

An authentication system 8 according to the present disclosure will be described with reference to FIG. 1. The authentication system 8 includes an authentication server 1, a provisioning server 2, and a user terminal 3. The authentication server 1, the provisioning server 2, and the user terminal 3 are bidirectionally communicably connected by a communication network 5.

The authentication server 1 authenticates the use of the provisioning server 2 by the user terminal 3. The authentication server 1 authenticates the user terminal 3 when the user terminal 3 uses an application provided by the provisioning server 2. The authentication server 1 may provide single sign-on.

The authentication server 1 issues token data for authenticating the user terminal 3 and transmits it to the user terminal 3. The authentication server 1 authenticates the token data upon receipt of the token data from the provisioning server 2 and transmits the authentication result of the token data to the provisioning server 2.

The authentication server 1 electronically signs, for example, a predetermined character string and generates token data. The authentication server 1 may also set a time limit for the authentication server 1 to authenticate the token data.

The authentication server 1 confirms that the token data transmitted from the provisioning server 2 is: (1) transmitted by the authentication server; (2) generated by the digital signature of the authentication server 1; and (3) received from the provisioning server 2 within a time limit set by the authentication server 1. When these are confirmed, the authentication server 1 transmits the authentication result to the provisioning server 2, including the fact that the token data is authenticated When at least one of these is not confirmed, the authentication server 1 transmits the authentication result to the provisioning server 2, including the fact that the token data is not authenticated.

The user terminal 3 receives the authentication by the authentication server 1 and uses an application service provided by the provisioning server 2.

The user terminal 3 acquires token data from the authentication server 1. The user terminal 3 transmits the token data to the provisioning server 2 and receives a registration code from the provisioning server 2. The user terminal 3 transmits the registration code to the provisioning server 2, and requests the establishment of a tunnel between an application processing unit 25 provided by the provisioning server 2 and the user terminal 3. When the tunnel is established, the user terminal 3 uses the established tunnel to benefit the application service provided by the processing unit 25.

The provisioning server 2 provides an application service used by the user terminal 3 through authentication by the authentication server 1. In this disclosure, a case will be described in which the provisioning server 2 includes a first processing unit 25a and a second processing unit 25b that provide application services. The provisioning server 2 can provide any number of services. In this disclosure, when the first processing unit 25a and the second processing unit 25b are not distinguished, they may simply be described as processing unit 25.

In this disclosure, an SSH tunnel is established between the user terminal 3 and the processing unit 25 that provides application services used by the user terminal 3. At this point, the authentication system 8 establishes the tunnel by sufficiently obtaining security even if the amount of data of authentication information that can be transmitted is limited, such as at the time of authentication before establishing the SSH tunnel, in the software for realizing SSH.

### Provisioning Server

As illustrated in FIG. 1, the provisioning server 2 includes data such as associating data 24, and functions of an authentication unit 21, the first processing unit 25a, and the second processing unit 25b. Each piece of data is stored in a memory device such as a memory 902 and/or a storage 903. The functions are implemented in a CPU 901.

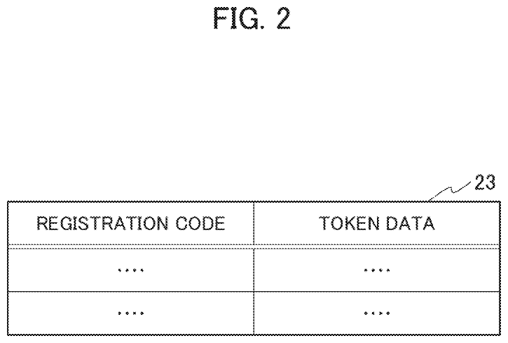

As illustrated in FIG. 2, the associating data 24 associates a registration code with token data. The token data is data transmitted from the user terminal 3 and is data for the authentication server 1 to authenticate the user terminal 3. The token data is generated by, for example, a digital signature of the authentication server 1. The registration code is data that uniquely identifies the token data transmitted from the user terminal 3.

The token data is originally data transmitted from the user terminal 3 to the provisioning server 2 when the user terminal 3 is authenticated by the function of the software for realizing SSH. The amount of data that can be transmitted when the user terminal 3 is authenticated is limited by the software specifications. In this disclosure, the amount of token data may exceed the amount of data specified by specifications of the SSH software. However, the registration code is within a range of the amount of data specified by the specifications of the SSH software.

The first processing unit 25a provides a first application service. The second processing unit 25b provides a second application service.

The authentication unit 21 includes an issuing unit 22 and a connecting unit 23.

The issuing unit 22 transmits a registration code associated with the token data to the user terminal 3 upon receipt of the token data from the user terminal 3. The authentication server 1 issues the token data to authenticate the user terminal 3.

The issuing unit 22 issues a registration code in association with the token data upon receipt of the token data, and stores the registration code and the token data associated with each other in associating data 24. The issuing unit 22 returns the issued registration code to the user terminal 3.

The connecting unit 23 receives a request to establish a tunnel between the processing unit 25 and the user terminal 3, and the registration code from the user terminal 3. The connecting unit 23 specifies the token data associated with the registration code received from the user terminal 3 from the associating data 24, and transmits the specified token data to the authentication server 1.

Here, the authentication server 1 confirms the token data and attempts authentication. The authentication server 1 transmits an authentication result including a statement whether or not the token data is authenticated to the provisioning server 2.

The connecting unit 23 establishes a tunnel between the processing unit 25 and the user terminal 3 upon receipt of the result indicating successful authentication from the authentication server 1. When the provisioning server 2 has a plurality of processing units 25, the connecting unit 23 establishes a tunnel with the processing unit 25 designated from the user terminal 3.

### Authentication Method

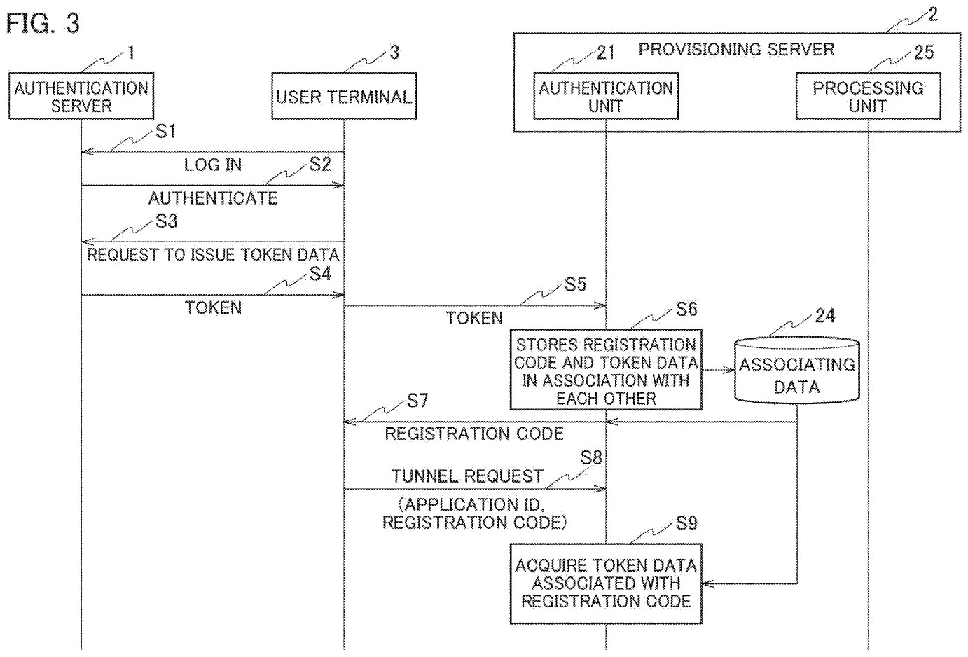

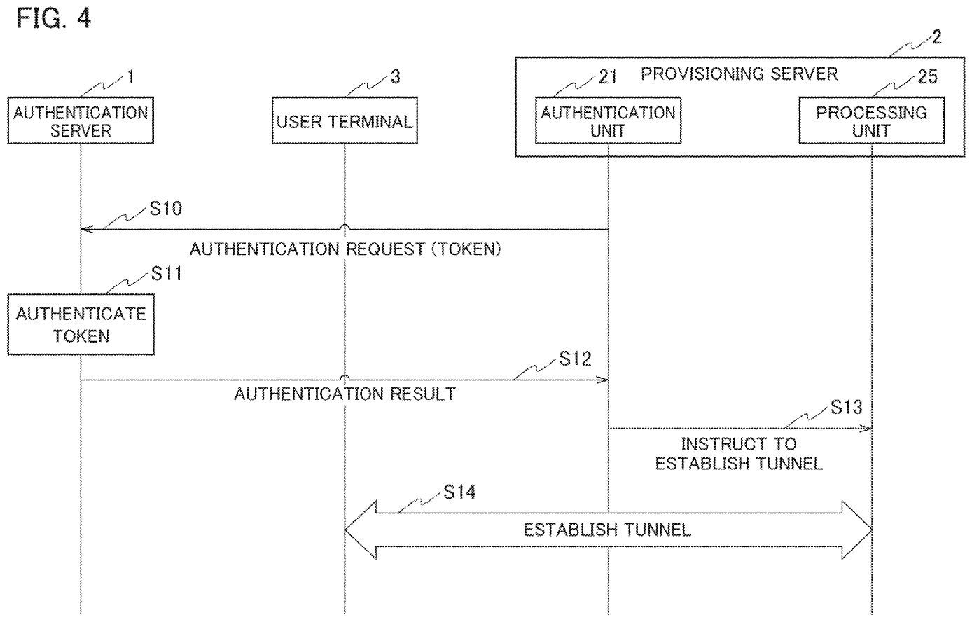

The authentication method according to the present disclosure will be described with reference to FIGS. 3 and 4.

In step S1, the user terminal 3 logs in to the authentication server 1. In step S2, the authentication server 1 authenticates the user terminal 3.

In step S3, the user terminal 3 transmits a request to issue token data to the authentication server 1. The authentication server 1 electronically signs predetermined data and generates token data. In step S4, the authentication server 1 transmits the generated token data to the user terminal 3.

In step S5, the user terminal 3 transmits the token data received in step S4 to the provisioning server 2. The user terminal 3 transmits the token data to the provisioning server 2 according to a Representational State Transfer Application Programming Interface (REST API) defined by the provisioning server 2.

In step S6, the authentication unit 21 of the provisioning server 2 issues a registration code for identifying the token data upon receipt of the token data. The authentication unit 21 stores the issued registration code and the received token data in association with each other in the associating data 24. In step S7, the authentication unit 21 transmits the registration code issued in step S6 to the user terminal 3.

In step S8, the user terminal 3 transmits a request to establish a tunnel to the provisioning server 2. The request includes an identifier of an application provided by the provisioning server 2 and the registration code received in step S7.

In step S9, the authentication unit 21 of the provisioning server 2 acquires token data associated with the registration code included in the request from the associating data 24 upon receipt of the request from the user terminal 3. Here, the provisioning server 2 can connect token data having a sufficient amount of data to ensure security with a tunnel request received from the user terminal 3.

In step S10, the authentication unit 21 transmits an authentication request of the user terminal 3 to the authentication server 1. The authentication request includes token data acquired from the associating data 24.

In step S11, the authentication server 1 authenticates the token data acquired in step S10. If the authentication is successful, in step S12, the authentication server 1 transmits the authentication result indicating successful authentication to the provisioning server 2. If the authentication is unsuccessful, in step S12, the authentication server 1 transmits the authentication result indicating unsuccessful authentication to the provisioning server 2.

In step S12, the authentication unit 21 of the provisioning server 2 receives the authentication result from the authentication server 1. If the authentication result indicating unsuccessful authentication, the provisioning server 2 rejects the request from the user terminal 3. If the authentication result indicating successful authentication, the provisioning server 2 transmits an instruction to establish a tunnel with the user terminal 3 to the processing unit 25 corresponding to the application ID received in step S8.

When the processing unit 25 of the provisioning server 2 receives an instruction to establish a tunnel from the authentication unit 21, the tunnel is established with the user terminal 3 in step S14. The user terminal 3 uses the established tunnel to benefit the application service provided by the processing unit 25.

According to the authentication system 8 as described above, the provisioning server 2 associates token data having the amount of data sufficiently ensuring security with a registration code within the range of the amount of data that can be transmitted as authentication information. The user terminal 3 requests the establishment of the tunnel using the registration code, and the provisioning server 2 transmits the token data associated with the registration code received upon request to the authentication server 1 to request the authentication of the user terminal 3.

Thus, the authentication system 8 can establish the tunnel sufficiently ensuring security even when the amount of data of the authentication information that can be transmitted is limited.

As devices usable for the authentication server 1, the provisioning server 2, and the user terminal 3 of this embodiment described above, for example, a general-purpose computer system comprising a CPU (Central Processing Unit, processor) 901, a memory 902, a storage 903 (Hard Disk Drive: HDD, Solid State Drive: SSD), a communication device 904, an input device 905, and an output device 906 are used. In this computer system, each function of each apparatus is realized by the CPU 901 executing a program loaded on the memory 902.

The devices may be implemented by one computer or multiple computers. The devices may be a virtual machine implemented in a computer.

Programs of the devices may be stored in a computer readable recording medium such as a HDD, an SSD, a Universal Serial Bus (USB) memory, a Compact Disc (CD), Digital Versatile Disc (DVD), or may be distributed over a network. The computer readable recording medium may be, for example, a non-transitory recording medium.

The present disclosure is not limited to the embodiments described above, and various modifications may be made within the scope of the present disclosure.

### REFERENCE SIGNS LIST

1 Authentication server
2 Provisioning server
3 User terminal
5 Communication network
8 Authentication system
21 Authentication unit
22 Issuing unit
23 Connecting unit
24 Associating data
25 Processing unit
901 CPU
902 Memory
903 Storage
904 Communication device
905 Input device
906 Output device

1. An authentication method for an authentication system including a user terminal; a provisioning server for providing an application, and an authentication server for authenticating a use of the provisioning server by the user terminal, the authentication method comprising:
the authentication server transmits token data to the user terminal, wherein the token data is used for authenticating the user terminal,
the user terminal transmits the token data to the provisioning server,
the provisioning server transmits a registration code associated with the token data to the user terminal upon receipt of the token data from the user terminal,
the user terminal transmits the registration code as authentication information to the provisioning server by SSH to request establishment of a tunnel between a processing unit of an application provided by the provisioning server and the user terminal,
the provisioning server receives the registration code from the user terminal and identifies the token data associated with the received registration code,
the provisioning server transmits the identified token data to the authentication server,
the authentication server transmits an authentication result of the token data transmitted from the provisioning server to the provisioning server,
the provisioning server establishes the tunnel between the processing unit and the user terminal upon receipt of the authentication result indicating successful authentication from the authentication server, and wherein
the size of the token data exceeds the size of data of authentication information that can be transmitted by SSH, and the size of the registration code is within the size of data of the authentication information that can be transmitted by SSH.

2. The authentication method according to claim 1, wherein:
the user terminal transmits the token data in accordance with a REST API defined by the provisioning server, and
the provisioning server transmits the registration code associated with the token data to the user terminal in accordance with the REST API.

3. The authentication method according to claim 1, wherein:
the authentication server generates token data by a digital signature, and
the authentication server includes in the authentication result a statement that the authentication server authenticated the token data when the authentication server confirms that the token data is generated by the digital signature of the authentication server.

4. An authentication system comprising:
a user terminal,
a provisioning server for providing an application, and
an authentication server for authenticating a use of the provisioning server by the user terminal, wherein:
the authentication server transmits token data for authenticating the user terminal to the user terminal; and transmits an authentication result of the token data transmitted from the provisioning server to the provisioning server,
the user terminal transmits the token data to the provisioning server and receives a registration code from the provisioning server; and transmits the registration code as authentication information to the provisioning server by SSH to request establishment of a tunnel between a processing unit of the application provided by the provisioning server and the user terminal,
the provisioning server comprises
a processing unit, including one or more processors, configured to provide an application,
an issuing unit, including one or more processors, configured to transmit a registration code associated with the token data to the user terminal upon receipt of the token data from the user terminal, and
a connecting unit, including one or more processors, configured to transmit the token data associated with the registration code to the authentication server upon receipt of a request for establishing a tunnel between the processing unit and the user terminal from the user terminal, and the registration code; and establish a tunnel between the processing unit and the user terminal upon receipt of a result indicating successful authentication from the authentication server, and wherein
the size of the token data exceeds the size of data of authentication information that can be transmitted by SSH, and the size of the registration code is within the size of data of the authentication information that can be transmitted by SSH.

5. A provisioning server comprising:
a processing unit, including one or more processors, configured to provide an application,
an issuing unit, including one or more processors, configured to, upon receipt of token data from a user terminal, transmit a registration code associated with the token data to the user terminal, the token data used for authenticating the user terminal,
a connecting unit, including one or more processors, configured to transmit the token data associated with the registration code to the authentication server upon receipt of a request for establishing a tunnel between the processing unit and the user terminal and the registration code as authentication information by SSH from the user terminal; and establish the tunnel between the processing unit and the user terminal upon receipt of a result indicating successful authentication from the authentication server, and wherein
the size of the token data exceeds the size of data of authentication information that can be transmitted by the SSH, and the size of the registration code is within the size of data of the authentication information that can be transmitted by the SSH.

6. A non-transitory tangible medium storing a program, where executing of the program causes one or more processors to perform operations of a provisioning server according to claim 5.
